(19) United States
(12) Patent Application Publication
(10) Pub. No.: US 2026/0310211 A1
(43) Pub. Date: Oct. 8, 2026

(54) AUTONOMOUS CONTROL DRIVING METHOD FOR BICYCLE-LIKE VEHICLE

(71) Applicant: Lihua Meng, Changshu City (CN)

(72) Inventor: Lihua Meng, Changshu City (CN)

(73) Assignee: Lihua Meng, Changshu City (CN)

(21) Appl. No.: 19/483,269

(22) PCT Filed: May 7, 2024
(86) PCT No.: PCT/CN2024/091293

§ 371 Date: Nov. 11, 2025

(30) Foreign Application Priority Data
May 14, 2023 (CN) 202310537250.8

(51) Int. Cl. G05D 1/495; B62J 45/413; B62K 11/00; G05D 109/10

(52) U.S. Cl. CPC G05D 1/495; B62J 45/413; B62K 11/007; G05D 2109/13

(57) ABSTRACT

The present application discusses relevant aspects of the operating principles of bicycles, and therefrom a method for driving a bicycle-like vehicle (a vehicle having front and back wheels such as a bicycle, an electric bicycle, and a motorcycle) according to directional requirements in an autonomous control mode is produced, so as to replace the driver in sensing balance and controlling the vehicle. In the present application, the straight line determined by ground contact points of the two wheels of a bicycle are used as an axis of rotation, and the rotational motion of the vehicle body relative to said axis is controlled via measuring and calculating relevant variables and changes to the turning angle of the direction wheel; in combination with adjustment requirements to the driving direction, control requirements for this movement are configured, so that vehicle balance control and driving direction adjustment are unified.

### TECHNICAL FIELD

This invention relates to the automatic control and management of the operation of a bicycle-like vehicle (a two-wheeled vehicle with wheels set in tandem, such as a bicycle, an electric bicycle, a motorcycle and so on, or a land transportation tool that can be developed from aforementioned models which have enclosed passenger space and leg-like devices, hereinafter referred to as a bicycle), in particular, to continuously adjusting the bicycle in an effective traveling state on the basis of directional requirement and the relevant running state, and to judging the dynamic balance of the running vehicle, so that it can meet the relevant requirements in terms of automatic operation.

### BACKGROUND ART

Currently, the commonly used tools of personal land transportation often have a number of problems. A bicycle requires the driver to sense and control the balance by himself, and in order to cope with the left or right leaning problem that occurs at its low speeds or when halting, the user is usually required to utilize the force of his legs engaged with the ground, which prevents the driver and passenger from being in a completely enclosed chamber, making the use of such vehicles restricted by the environment very much, and can be very inconvenient in bad weather (cold, heat, wind, rain, etc.). A smaller three- or four-wheeled vehicle, for its narrower track left to right side, cannot easily cope with the side wheels' undulations and the high centrifugal forces during cornering, resulting in its limited performance and spatial utilization. Cars, on the other hand, take up a lot of resources, their area occupation, energy consumption and production costs are all high, causing a series of problems such as congestion, parking difficulties, and high travel costs; statistics show that in most of the cars on the road there is only one person, very few cases in which three or more passengers are in one car simultaneously, which is a remarkable reflection that the resources are being wasted. If there is an effective way to automatically measure and control the balance of a bicycle during running, then it is also possible to install devices (leg-like facilities) which can functionally replace the driver's legs to act when necessary, so that the driver or passenger can be in a completely enclosed chamber, which makes it possible for this type of vehicle to adapt to a wide range of environmental conditions, and to improve its configurations like safety. Enclosed chambers also make it easy to achieve a low wind resistance profile for such vehicles, which improves their efficiency when traveling (especially at high speeds). The application of automatic driving control can save the driver's effort in balance controlling and improve their sitting and handling posture, and it is also a necessary condition for the realization of autonomous driving of this type of vehicles. In conclusion, the realization of automatic driving control for this type of vehicles can realize their greater potential, and achieve relative advantages in terms of comfort, convenience, energy saving, economy, and space occupation, etc., and save the relevant resources for the society and realize greater application value.

### DISCLOSURE OF INVENTION

### Overview of Contents

In order to realize automatic judgment and regulation of the balance status of a running bicycle, this invention attempts to find the relevant factors affecting the operation of a bicycle from its unique structural and operation characteristics, and by analyzing the relation between the active and passive variables therein, to provide a method for monitoring and adjusting the relevant contents, so as to achieve the purpose that a machine can effectively recognize and control the operation state of a bicycle.

### Analysis Method and Introduction to Related Content

During the running of a bicycle, the plane (usually the plane is the ground, hereinafter take it as the ground) supporting its motion has two contact points (or can be called the engaging points, below abbreviate them as ground contact points) with the bicycle's two wheels, in this specification, the line linking the two ground contact points is taken as a rotation axis (hereinafter take it as the ground contacts' axis) and the bicycle body's rotation motion with respect to the ground contacts' axis is related to the operation of the bicycle. As shown in FIG. 1-i (drawing i of the FIG. 1, the same applies below), the two contact points between the bicycle's wheels and the ground are A and B; in order to facilitate the description of the state of the vehicle, the straight line BA is vectorized and the direction is from B to A; during the bicycle's running, if the angle between the forward direction of its center of mass and the direction of the vector BA is less than 90 degrees, it is stipulated that A is in the front and B is in the rear. In this description, we first take a typical bicycle's structure as an example and analyze it, the front wheel of this bicycle is the steering wheel (directional wheel), CJ is the rotation axis (directional axis, circling axis, control axis, etc.) of the front wheel, and the rear wheel cannot be actively rotated, and the axes of the front and rear wheels are points C and D, which are unchanged in their spacing. The intersection line of the plane where the front wheel is located (hereinafter referred to as the front wheel plane) and the ground is AR, and for the rear wheel it is BK. In this description, the bicycle travels under the condition that the wheel carries out a non-slip rolling on the ground, i.e., the points A or B will not move in the direction perpendicular to AR or BK. In this specification, the plane formed by the center of mass of the bicycle and the ground contacts' axis is called the plane of center of mass; the plane of symmetry (left versus right) of the bicycle, or the plane formed during the time that the front wheel plane and the rear wheel plane are the same one, then this plane is called the vehicle body plane (JCD in FIG. 1-i); and the rotational speed of the bicycle body with respect to the ground contacts' axis, i.e., the spatial rotation speed of the plane of center of mass with respect to the ground contacts' axis, is called the angular velocity of the vehicle body (denoted by ω), and the rate of change (the derivative) of ω is the angular acceleration of the vehicle body (denoted by ω′). In this specification, from the rear viewpoint of the vehicle to describe its motion state, denote the ω a positive value (+) when the vehicle rotates counterclockwise, and vice versa, a negative value (−) will be given; when ω increases, ω′ is denoted by a positive value (+), and vice versa, a negative value (−) will be given. The direction and magnitude of the angular velocity and angular acceleration of the vehicle body are also collectively referred to as the rotational state of the vehicle body in this description.

### Denotation for the Steering Angle and Target Steering Angle

As shown in FIG. 1-ii, on the coordinate axis, the angle between the front wheel plane and the vehicle body plane is represented by the angle ∠TOY (denoted by α) which is the angle between OT and OY. When OT is coincident with OY, i.e., when α is 0, the front wheel plane coincides with the vehicle body plane, the bicycle will keep a straight travel on the flat ground in this state (in FIG. 1-i, AR and BK will be collinear). When the bicycle is turning to the left, i.e., when OT is located on the left of OY, the angle of α is denoted to a positive value (+), and relatively will be denoted as a negative value (−) when OT is on the right. In this way, the magnitude of α indicates the travel direction angle (forward angle, steering angle, etc.). using OT′ and the angle ∠YOT′ which is formed by OY and OT′ (denoted by α₀) to indicate the target travel direction (destination direction, required direction, etc.) the vehicle is receiving, then the magnitude of α₀ is the target steering angle, and its value is expressed in the same way as α.

### The Changing of the Force to the Ground Contacts' Axis Caused by the Change of α

As shown in FIG. 1-i, if AR, the intersection line formed by front wheel plane and the ground, has another intersection point A₁ with the front wheel, then A₁ is both on the wheel and on the ground, that means the wheel and the ground have two contact points A and A₁ at the same time, which cannot be established, so it can be proved that there is only one point of intersection for the AR and the wheel, that also means, AR and the wheel are tangent. Assuming during the bicycle's travel, the conditions affecting the motion curvature of the two ground contact points A and B remain unchanged, that is, the angle α which is formed by the front wheel plane and the vehicle body plane is unchanged, the angle formed by vehicle body plane and the ground is unchanged, the ground is flat without undulation, then in this state, the trajectories of the ground contact points are straight lines or arcs. FIG. 1-iii shows when the trajectories A and B are circles under the above conditions, their trajectory arcs are AA′ and BB′. The center of AA′ is O₁, we connect A and O₁. Because the relevant geometric relationship formed in this state remains unchanged, that is, the angle formed by AO₁ and AR will always be equal. Thus, if AR has another point of intersection A′ with arc AA′, connect O₁A′, then we get ∠RAO₁=RA′O₁. Since ∠RAO₁=∠RA′O₁+∠A′O₁A, ∠A′O₁A>0, so ∠RAO₁=∠RA′O₁ cannot be established, which proves that AR and AA′ have the only one intersection point, i.e., when the trajectory of point A is not a straight line, AR is tangent to the trajectory curve of point A at all times. Connecting O₁B, due to the invariance of geometric relations, the lengths of AB and AO₁, and the angle of ∠O₁AB will remain the same, so the length of O₁B is also invariant, i.e., O₁ is also the center of the arc BB′. In FIG. 1-iii, let BK, the intersection line of the rear wheel plane and the ground, intersect with AR at point K. In the operation of a bicycle, BK and BA do not often coincide, but the angle between them and its effect is relatively very small, here we ignore this difference first and take AB and KB as the same line, so AB⊥O₁B, ∠AO₁B=∠RAB. During the bicycle's running, ∠RAB and α usually do not change by 1:1, but their proportional coefficient is positive. We set ∠RAB=λα (the magnitude of λ is related to the current value of α, the structure of the vehicle and the angle between the vehicle body plane and the ground, usually the value is between 0.6 and 1.0). We use d to denote the length of the segment AB, this length will change when the bike is running, but it is relatively small and also ignored for the moment. AO₁ and BO₁ are the radii of curvature of the motion of the two points A and B, which are respectively denoted by R_{A} and R_{B}, so that we can get R_{A}=d/sin(λα) and R_{B}=d/tan(λα). Respectively, let's set the ground moving speeds of points A and B are V_{A} and V_{B}, and according to the centripetal acceleration formula a=V²/R, the magnitude of the centripetal acceleration at points A and B are sin (λα)·V_{A}²/d and tan (λα)·V_{B}²/d, respectively. Setting the change of α in a tiny time dt as dα, the change of centripetal acceleration of points A and B are respectively sin (λdα)·V_{A}²/d and tan (λdα)·V_{B}²/d, and the changes in the direction perpendicular to AB are both tan (λdα)·V_{B}²/d. This indicates that, when the bicycle is traveling, the lateral acceleration of the ground contacts' axis (along the direction of the ground) can be changed by changing the magnitude of α, that is to say, the force from the ground to the ground contacts' axis's left or right side can be changed, and the effect of this change is not only affected by the change of α, but is also proportional to the square value of the vehicle speed.

### The Relation Between the Change of α and the Angular Acceleration of the Vehicle Body

As shown in FIG. 1-iv, O is denoted to be the center of mass of the vehicle, vector OG is the gravitational force on the bicycle, vector OL is the relative inertial force on the vehicle body when AB is accelerating in the left-right direction along the ground, and vector ON is the combined force on the bicycle from other external forces such as wind. Let OF be the projection of the vector sum of OG, OL and ON onto the plane perpendicular to AB. In FIG. 1-v, passing through point O, make OP perpendicular to the ground contacts' axis AB and intersect it at P; plane HAB represents the plane of motion of the ground contacts' axis AB, HP⊥AB; and make OM⊥OP and MF∥OP in the plane of OPH, and use OP to represent the orientation of the vehicle body in the direction perpendicular to AB, and use the vector OM to represent the component of OF in the direction perpendicular to OP. Without considering the changes of other factors, take the case when α is positive and increasing as an example, at this time, the force on the ground contacts' axis AB or point P in the direction of HP is increasing to the left; the vector PE is used to denote the amount of change of the force on point P, and the vector OL′ is used to denote the change of the relative inertial force of the vehicle, which is equal to the opposite of vector PE. Since the application point of vector PE is not at the center of mass of the vehicle body, and there is no corresponding force couple, this force causes the vehicle body OP to undergo acceleration changes in both rotation and translation, and the amount of change in translation (OQ in FIG. 1-v) is less than itself or OL′. The difference between OL′ and OQ is denoted by OS, and OF′ and OM′ illustrate the result of the change in OF and OM. It can be seen that the change in α causes an asymmetric change of the force acting in the direction perpendicular to the vehicle body, and the angular acceleration of the vehicle body is then changed, and thus the control of the angular velocity of the vehicle body can be realized. OF or OF′ can be regarded as the combined external force on the vehicle body with respect to the ground contacts' axis; the product of OP and OM (or OM′) can be regarded as the magnitude of the relative moment on the vehicle body with respect to the ground contacts' axis. If the bicycle is assumed to be at rest before the change of α, it is equivalent to the ground swaying left or right during the change of α, so this can also be considered as an inverted pendulum model.

### The Impact of the Ground Condition on the Control of the Angular Acceleration of the Vehicle Body

In the above discussion, it is assumed that the bicycle is running on the flat ground, whereas the actual ground is often rugged to some extent. However, the effect of the ground contacts' axis on the angular acceleration of the vehicle body is only related to the current (instantaneous) force it subjected to, and its trajectory can be regarded as consisting of constantly formed instantaneous motion planes. As long as the current motion plane formed by the ground contacts' axis does not coincide with the plane of center of mass, a change in α will cause a change in the angular acceleration of the vehicle body, and this regulation method will be effective. Changes in the angle formed by the plane of center of mass and the instantaneous motion plane of the ground contacts' axis affect the regulation of the angular acceleration of the vehicle body, but it can be adapted by changing the rate of change of α. In FIG. 1-i and FIG. 1-iii, it can be regarded that, AR and BK are on the instantaneous motion plane formed by the ground contacts' axis, and they are changing synchronously with the motion of the ground contacts' axis, rather than being on the actual ground; the influence of (very small) changes in the length of AB and the magnitude of ∠ABK on the force on the ground contacts' axis can also be adjusted during the changing of α. It can also be seen that no specially prepared ground is required for the operation of the bicycle, and most road conditions can accommodate it.

### The Incidental Effect when α Changed

As shown in FIG. 1-i, let AC and BD be the representative paths of the interaction force transmitted between the body of a bicycle and the ground. In FIG. 1-vi, ∠DPC (∠DBC, ∠DAC) is the angle between AC and BD in the direction perpendicular to AB (hereinafter referred to as the left-right direction). Normally, in the operation of a bicycle, when a force is applied to change α (at this time the bicycle body can be seen as two parts, both having angular acceleration with respect to the rotation axis AC), ∠DPC also changes, causing points C and D to interact with A and B via forces in the left-right direction. Since A and B are in the state of acceleration change at this time, the forces on points C and D will be different, which will cause the center of mass point O to accelerate in the same direction as the point P. For example, when α is positive and increasing due to the applied force, the acceleration of AB to the left is increasing, and the force to the left on point C is greater than the force to the right on point D, which on the whole causes point O to be subjected to a net force to the left and its acceleration to the left increases. This effect reduces the change in the angular acceleration of the vehicle body caused by the change in α and reduces the angle between the orientation of the vehicle body (OP in FIG. 1-v) with respect to the relative combined external force (OF′ in FIG. 1-v). Since the angular acceleration of the vehicle body caused by the change in α is larger in most cases, this resulting effect is favorable for the control of the rotation of the vehicle body, except at very low speeds. If other conditions are the same, the magnitude of this effect is related to the structure of the vehicle body, e.g., in FIG. 1-i, the smaller the angle between CD and JC (the steering wheel's rotation axis), the larger the change in the angle between CA and DB when α is changing, and the impact of this effect will be larger.

### The Influence of Gyroscopic Effect

As shown in FIG. 2-i, a gyroscope with axis MN is rotating on a stand, let P be a point in the space through which the outer edge of the gyroscope is passing, and O be the center of the gyroscope. Consider a slat whose surface is perpendicular to OP, and whose motion speed and direction are kept the same as the mass point of the gyroscope passing through the point P. In this way, when the gyroscope's spinning plane or the axis of MN remains its spatial angle and position the same, the slat keeps running in a straight line; and when the axis MN of the gyroscope rotates around OP, the motion direction of the slat is also changing from time to time. Similar to that in FIG. 2-ii, when there is no external force, the object will maintain a constant speed in a straight line (section A′B′); when there is a centripetal force F (section B′C′) the object will move with a curvature and rotate around O′; when the centripetal force is removed (after point C′) the object will continue to move with a constant speed in a straight line due to its inertia. Changing the spatial angle of the plane of the spinning gyroscope (or the gyroscope's axis) is equivalent to changing the curvature of motion of the mass points in the gyroscope. This means that when the gyroscope rotates, inertia keeps the angle of the gyroscope plane unchanged in space; under an external force, the gyroscope plane will rotate, and then the gyroscope will also produce a opposite force on the object applying the force. When a bicycle is traveling, its two wheels or other rotating devices (such as motors) mounted on its body will play similar roles like the gyroscopes, that is, produce reverse force to the rotation of the vehicle body with respect to the ground contacts' axis. This effect helps to reduce the angular velocity of the vehicle body, extends the reaction time required for the control of the system, and also helps to stabilize the changing of α. However, the mass of rotating mechanisms such as wheels usually takes a small percentage of the vehicle body, and its effect is even more limited at lower speeds. However, we can also choose to actively add such mechanisms, that is, install gyroscope-like devices with their rotating axis are relatively perpendicular to the ground contacts' axis, and keep them running at a higher speed when needed, which can increase the stability of the vehicle body and reduce the difficulty of controlling the angular velocity of the vehicle body. Because the rotation motion of the bicycle's wheels' axles (or wheels' planes) in other direction was restricted by the bicycle body (in FIG. 1-i, the rotation of front wheel plane around JC is controlled, the rear wheel plane's rotation around CD is controlled, these movements are bound to the movement of the vehicle body), and the rotation of the vehicle body along the ground is confined by the friction between points A and B and the ground, so these do not affect the change in the angular velocity of the vehicle body, so they will not be discussed here.

### Control of the Angular Velocity of the Vehicle Body with the Combination of the Directional Requirement

From the above analysis, it can be concluded that the force the bicycle body is subjected to can be actively changed by changing α when there is a certain vehicle speed. If the rate of change of α is adjusted at the right time so that it can cope with unexpected factors (side winds, ground undulations, etc.) under usual conditions, the magnitude of the angular acceleration ω′ of the vehicle body can be controlled, and thus the angular velocity ω of the vehicle body can be controlled. In this way, in conjunction with the driver's requirements for the direction of current travel, the rotation of the vehicle body around the ground contacts' axis can be controlled by adjusting α, then the requirements for the operation of the bicycle can be realized. As shown in FIG. 2-iii, the X-axis represents the time, and the variations of ω, ω′ and α with time are represented in the Y-axis. Let the current target steering angle α₀ be constant, then at this time the ideal requirement for the angular velocity of the vehicle body is that ω remain constantly zero, and the corresponding control goal is to adjust ω to be constantly approaching zero. Starting from the origin O of the coordinate axis, the vehicle body starts to rotate counterclockwise under the impact of the side wind, and ω and ω′ are increasing together. At point A, combined with the current vehicle speed, the control system starts to make feedback according to the changes of ω and ω′, i.e., it starts to increase the angle of α. Points B and C are the inflection points of ω′ and ω. Since it is always in dynamic adjustment, it cannot and does not need to reach the target value completely, so by point E, when the angular velocity of the vehicle body is close to the target value, this regulation phase can be considered complete. When regulating, the rate of change of α depends on the situation, if ω and ω′ grow faster after point A, the angular velocity of α needs to be increased to accelerate the arrival of the inflection points of B and C, and in the opposite case, the change of α needs to be slowed down. After point C, when the angular velocity of the vehicle body is close to the target value (refer to point D), the rate of change of α needs to be adjusted to make ω′ tends to 0, so that it is easy for ω to converge at the target value. If the inflection points of ω′ and ω do not appear within a set period of time after point A, or if ω fluctuates greatly and is difficult to approach the target value, then the regulation failed, and at this time it is necessary to intervene in other ways (e.g., lowering the leg-like device).

### The Defining of the Average Travel Direction

When controlling the vehicle's rotational state, α needs to be constantly changing, and it is often in a dynamic cycle, nor does it coincide with the driver's indicated direction angle α₀. We take the average value of α over a certain historical period or its average value over a change cycle (denoted by α̅) as the vehicle's traveling direction angle instead of taking its current value (i.e., the instantaneous value) as the vehicle's traveling direction angle. Correspondingly, the average value of the vehicle's traveling curvature over a certain historical period or a change cycle is taken as the measure value of its traveling direction. If α₀ and α̅are the same (since these two values are changing all the time, it can also be regarded that they are the same when they are very close), then the overall (in a longer period of time) direction of travel and the target direction are the same, which can satisfy the requirement for the bicycle's travel. The difference between α₀ and α̅ (the magnitude of α₀−α̅) can be referred to as the direction difference. If the motion curvature of point P in FIG. 1-v is used to represent the traveling curvature of the vehicle, its curvature of motion when turning to the left can be denoted by a positive value (+), and correspondingly, its curvature when turning to the right can be denoted by a negative value (−). In this way, a positive direction difference indicates the requirement to increase the vehicle's traveling curvature, and vice versa for decrease. The requirement for the travel direction is actually the requirement for the travel curvature of the vehicle, but for the driving of a bicycle, it is sufficient to indicate whether the requirement for the curvature of travel is to be increased or decreased without considering and calculating the magnitude of its actual value. Since the travel curvature is generally proportional to α̅, we can indicate the requirement for a change in travel curvature in terms of the required value of α̅ (α₀).

### Adjusting the Travel Curvature of the Vehicle

Because (within a certain period of time) the amount of change in the angular velocity ω of the vehicle body is the integral value of the angular acceleration ω′ of the vehicle body, if the angular acceleration maintains a certain magnitude (absolute value) for a relatively long time, it will cause a drastic change in the angular velocity, which is likely to make the vehicle body lose control and fall laterally. That means, as shown in FIG. 1-v, OF either swings (rapidly) around OP, or the angle between it and OP should be relatively small. So the direction of the relative combined external force on the vehicle body has to move spatially in the same way as the vehicle body, overall (over a longer period of time) they should be synchronized (averagely the position of OF has to be near OP). Thus, we can rotate OP and OF together to realize the adjustment of the curvature (travel direction) of the vehicle. When the direction difference is positive, ω can be adjusted to be in a positive certain value range, that is, to let the vehicle body rotate counterclockwise at a certain speed, for example, we can try our best to control ω′ to be 0 after ω reaches the set value, so that the vehicle body carries out a counterclockwise rotational movement at a relative constant speed, at which time, OF and OP are relatively aligned and rotate synchronously. Adjusting the direction of OF is the result of adjusting the vector OS, and the change in OS is the result of the change in α. In this way, α and α̅ are gradually increasing as the vehicle body is controlled to rotate counterclockwise, and when α̅ is consistent with α₀, this regulation phase can be completed. By the same reasoning, if α₀ is smaller than α̅, the vehicle body will be controlled to rotate clockwise until the two values become the same. The vehicle body's rotation speed ω should be set according to the vehicle's (relevant) running state. For different speeds, different vehicle body rotation velocity are required for changing the same travel curvature, that is, to adjust the same travel curvature over the same period of time require different values of ω; and the value of the direction difference (here refers to its absolute value, the same followed) indicates the urgency of changing the travel direction, so the vehicle speed and the value of the direction difference can be used as a basis to set the target value (the ideal value) of ω. The setting of the rotation speed of the vehicle body can also be adjusted accordingly by combining the information of the vehicle's bumpy state, the change of wind, whether the road surface is slippery or not, and the swaying of the passengers and objects on the vehicle, so as to improve the safety. Due to the uncertain factors, the regulated results often fluctuate around the target value, therefore, based on the specific operating conditions of the vehicle, an acceptable range (a feasible variable interval) for the controlled values can be set. The setting of the target value of ω′ can be combined with the difference between the current vehicle's ω and the set value of ω, and the target value of ω′ can be set proportional to the magnitude of this difference; and the rotation inertia of the steering wheel can be taken into account, so that the relevant variables will fluctuate less to achieve a better control effect. The actual controlled value of ω′ will also fluctuate around its set value, and the same reasoning can be used to set its acceptable deviation. The magnitude of the direction difference and the differences between the rotational state of the vehicle body and the set values can be used as the judgment basis of the vehicle's operation state (the bicycle's balance); If ω and ω′ exceed the acceptable interval (the gap between the actual controlled value and the set value is too large) or the direction difference is too large, that means the control process has failed. In practice, ω′ and ω change very quickly, unless α₀ changes drastically or uncontrollable factors are large, generally α̅ will approach α₀ very fast, the requirement of adjusting the vehicle's travel curvature can be fulfilled relatively quickly. In FIG. 2-iii, it can also be regarded that a large deviation of ω and ω′ from the ideal value happened to the vehicle due to the external force, and in the process of adjusting these variables, α̅ became larger than α₀, at that time (which can be regarded as starting from the point C) the system began to control the vehicle body according to this direction difference to make it rotate clockwise, which also means that it controls ω′ to reduce ω to a negative value, and to adjust ω′ and ω to zero when α̅ is close to α₀. It can also be seen from this example that α and ω fluctuate (to varying degrees) even when α₀ (the required travel curvature) is always constant. Due to the rotational inertia of the steering wheel and the vehicle body, rapid oscillation of the steering wheel (α fluctuates back and forth around a certain value) is not recommended because of the risk of failing to stabilize ω and the high wear and tear on the vehicle body and energy consumption. A safer solution is to control the angular acceleration of the vehicle body in a smaller range, so that although the change of ω and the adjustment of the direction difference will be slower, it is easy to keep the vehicle in a stable controlled state, and the fluctuation of α in this state is relatively small.

### The Measurement of the Angular Velocity of the Vehicle Body and Relevant Variables

We can install a gyroscope (angular velocity sensor) on the vehicle body to measure its angular velocity and calculate the angular acceleration. The angular velocity of the vehicle body (here referred to as the target value) is the rotational velocity of the plane of center of mass around the ground contacts' axis, which generally can not be measured directly. We can choose a rigid body's plane that rotates synchronously with the plane of center of mass as the measured plane and measure its rotation speed in the relevant direction as a reference value, such as in FIG. 1-i, we can choose to measure the rotation velocity of the vehicle body plane JCD around CD. When the bicycle is running, the rotation around the directional axis of the steering wheel and its related accessories, the action of the vehicle damping device, the difference in tire pressure, and the shaking of the passengers and goods, etc, may all cause the relative movement of the position of the center of mass; and the change of the angle between the wheels' plane and the ground will also cause the ground contact points shift left or right around the center line of the outer edge of the wheel; these factors tend to cause difference between the target value and the reference value. These errors can be determined according to specific models in different operating conditions to obtain more accurate value of the angular velocity of the vehicle body. If the gyroscope can measure the angular change of the vehicle body plane in its own direction (such as the angular change of CD on the plane CDJ in FIG. 1-i), it can help to get the bump state of the vehicle. The measurement and regulation of α can be carried out by the servo mechanism; there are various ways to choose to input α₀ to the computer and measure the speed of the vehicle, which will not be discussed here.

### The Scheme of Regulation with Single Wheel or Double Wheels

From the above analysis, it can be concluded that such vehicles can also use its rear wheel as the steering wheel to adjust the angular acceleration of the vehicle body or use the front and rear wheels to rotate to steer together, as long as the rotation of the steering wheel (or wheels) can change the force the ground contacts' axis is subjected to (or the travel curvature of the vehicle). As in FIG. 1-i, if JD is the circling axis of the rear wheel, the scheme of letting the rear wheel plane rotate around JD or the scheme of co-rotating the front and rear wheels around JC and JD respectively, can also be used. The use of two wheels' co-regulation will greatly improve safety because the probability of two independent systems failing at the same time is extremely low; if a problem occurs in one steering wheel system, the other system can maintain control of the vehicle until it comes to a safe stop, which greatly reduces the incidence of accidents. Dual-wheel regulation also increases the flexibility and precision of the control, as single-wheel regulation may at some point result in the difference between α̅ and α₀ widening first, whereas the dual-wheel scheme can better avoid this situation and respond faster to the requirement of travel direction regulation. The two-wheel regulation scheme may need consider the different effects on the vehicle's travel curvature when the two angles formed by the two wheel planes and the vehicle body plane change, such as in FIG. 1-i, if ∠JCD and ∠JDC are different in size, then even if the angles formed by the front and rear wheel planes with the vehicle body plane are the same in size (excluding the case when they are both zero), their effect on the vehicle's travel curvature is different, which needs to be measured according to the specific vehicle model (refer to the scale factor λ mentioned above, the two λ of the two wheels and their ratio needs to be known).

The Effect and Countermeasures of the Changes in Other Factors like Speed

If the vehicle's travel curvature (or α) is not zero, changing the driving speed can also regulate the angular acceleration of the vehicle body, but changing speed is related to the factors like driving requirements and safety, should be controlled by the driver, and the machine is usually not appropriate to actively intervene it. However, in some cases, such as the driver wants to quickly change the traveling curvature (“sharp turn”), which is manifested in the sharp increase in the difference of α̅ and α₀; by the normal control, the time for α̅ to reach the α₀ will be too long, and the driver's turning needs can not be meet timely. In this situation, the method of reducing the vehicle speed can be considered to assist in accomplishing the rapid adjustment of the vehicle's traveling direction, and of course, this regulation approach can also be set as an option for the user to configure by himself. As mentioned earlier, the rotational movement of the steering wheel also has inertia, resulting in a certain amount of time needed for the change of α. In order to cope with the change in the angular acceleration of the vehicle body brought about by the change in the vehicle speed, according to the user's speed regulation instruction, α can be adjusted in advance before the actual change in the vehicle speed, so as to better regulate the rotational state of the vehicle body. If it is possible to detect the relative movement of the physical entities carried by the vehicle, such as passengers and objects, and to anticipate the effects of such movement, then it is also possible to control α to respond in advance; changes in terrain and wind or other related factors, if can be predicted, can also be added to the reference content of the regulation.

### BRIEF DESCRIPTION OF DRAWINGS

FIG. 1 is the analytical diagram of the relevant factors involved in the operation of a bicycle;

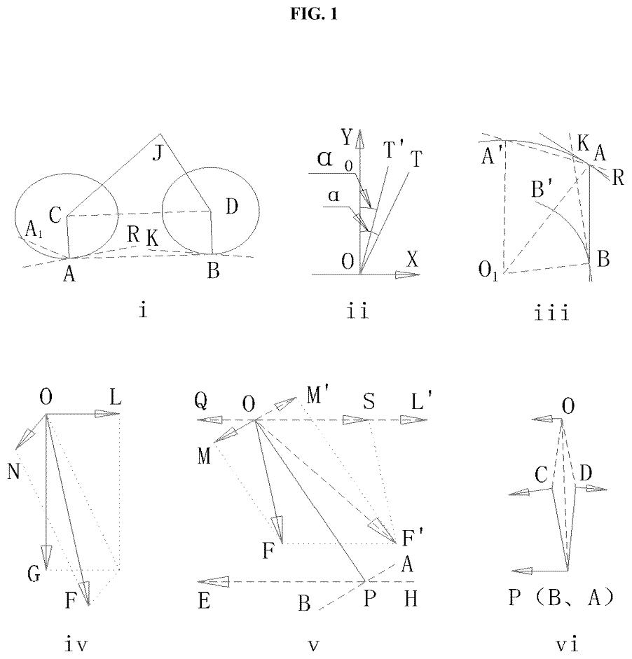

FIG. 2 is the analytical diagram of the gyroscopic effect affecting the bicycle's operation and the trend of the relevant variables when controlling the bicycle's operation.

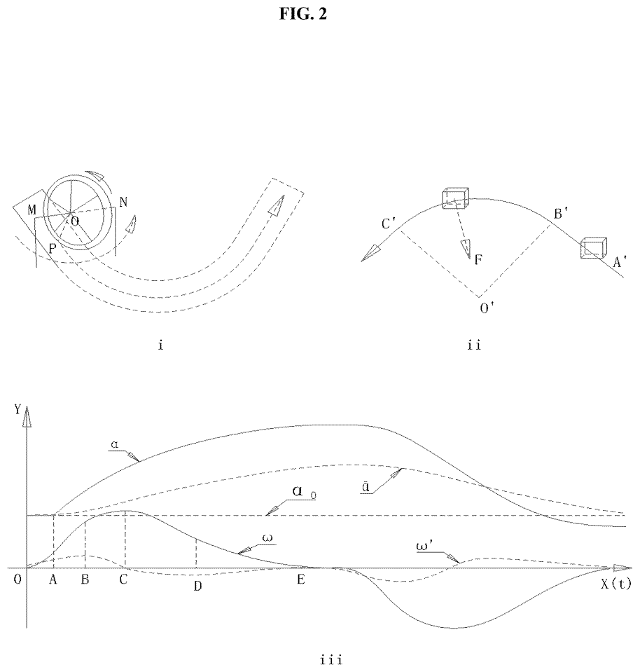

### MODES FOR CARRYING OUT THE INVENTION

Specific implementations and considerations for each process have been given in this description, so only selective brief descriptions of these are given here. The speed of rotation of the bicycle body around the ground contacts' axis (denoted by ω) is measured by a gyroscope, and the angular acceleration (denoted by ω′) is calculated therefrom. The steering angle of the bicycle's steering wheel (denoted by α) is measured and controlled by using a servo mechanism, and ω′ is controlled by controlling the change in α. The average value of α over a certain historical period (denoted by α̅) is taken as the travel direction, and the difference between the required direction (denoted by α₀) and the travel direction is referred to as the direction difference (α₀−α̅). Based on the direction difference information and factors like vehicle speed, the target values of ω and ω′ are set, and then α is controlled to make ω close to the target value to eliminate the direction difference. In short, ω′ is controlled by controlling α, ω is controlled by controlling ω′, and α̅ is constantly converging to α₀ by controlling ω close to its set value; the difference between the rotational state of the vehicle (ω and ω′) and their set values and the magnitude of the direction difference can be judged as the relative balance (stability, safety) of the vehicle's operation.

1. A method for operating a bicycle-like vehicle under automatic control according to a directional requirement, characterized in that: a straight line determined by ground contact points of the vehicle's front and rear wheels is used as a rotation axis; a rotational motion variable of the vehicle body relative to said axis is determined; a control requirement for said variable is set based on a travel direction adjustment demand; and said requirement is achieved by controlling a change in a steering angle of a steering wheel.

2. The method of claim 1, characterized in that: said travel direction is quantified not by a current value of the steering angle of the steering wheel or a traveling curvature of the vehicle, but by an average value of said variable over a historical period or a change cycle.

3. The method of claim 1, characterized in that: regarding said control requirement, a requirement for a rotational direction of the vehicle body is determined by a sign of a direction difference, and a requirement for a rotational speed of the vehicle body is determined by an operational state of the vehicle.

4. The method of claim 1, characterized in that: said determination of the rotational motion variable of the vehicle body relative to the axis comprises measuring an angular velocity using a gyroscope and calculating an angular acceleration based thereon.

5. The method of claim 1, characterized in that: said steering wheel is a front wheel of the vehicle, a rear wheel of the vehicle, or operates in a coordinated mode involving both the front and rear wheels.

6. The method of claim 1, characterized in that: an effectiveness of the method's implementation is determined by a magnitude of an absolute value of the direction difference and a deviation of the rotational motion variable of the vehicle body from a set value thereof.

7. The method of claim 4, characterized in that: a control target for said angular acceleration is set based on a deviation between the angular velocity and a set value thereof; and wherein, if information predictive of a change thereof is available, relevant control is performed proactively.

8. The method of claim 1, characterized in that: control of said variable may utilize adjustment of a vehicle speed as an optional auxiliary means when a demand for a travel direction change is urgent; a gyroscopic apparatus having a rotation axis substantially perpendicular to the ground contact axis may be installed and rotated when necessary to reduce difficulty of this control task; and a magnitude of steering angle change required for altering the angular acceleration is inversely proportional to the square of the vehicle speed and is further determined by considering factors including a vehicle body structure, an angle between a plane of center of mass and the ground, and gyroscopic effects.

9. The method of claim 3, characterized in that: said operational state of the vehicle includes, in addition to the vehicle speed and the absolute value of the direction difference, a bump state of the vehicle, a wind force variation, a road slipperiness, or a swaying of a carried object; and wherein information on the bump state of the vehicle is obtained by measuring, using a gyroscope, an angular change of the vehicle body within its own plane.

10. The method of claim 2, characterized in that: values of said steering angle and said traveling curvature are recorded as zero when the vehicle travels straight, opposite signs are used to represent different turning directions, and magnitudes of the values are determined by a deviation from a state of straight travel.

11. A front-and-rear-wheeled vehicle having functionality for autonomous balance management and travel direction adjustment, characterized in that: a straight line determined by ground contact points of the front and rear wheels is used as a rotation axis; a relative angular velocity of the vehicle body with respect to said axis is determined; said angular velocity is controlled by adjusting a steering angle of a steering wheel; when no travel direction adjustment is required, the angular velocity is controlled to continuously approach zero; and when a travel direction adjustment is required, the angular velocity is controlled to remain within a defined range.

12. The vehicle of claim 11, characterized in that: said travel direction refers to an overall traveling direction of the vehicle, disregarding influences of short-term or minor variations in the steering angle or the traveling curvature, and is represented by an average value of said variable over a historical period or a change cycle.
